(19) United States
(12) Patent Application Publication
(10) Pub. No.: US 2004/0123072 A1
(43) Pub. Date: Jun. 24, 2004

(54) Method and system for modeling non-interlocked diversely bypassed exposed pipeline processors for static scheduling

(75) Inventors: Krishnan Kunjunny Kailas, Ossining, NY (US); Ayal Zaks, Misgav (IL)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/321,654

(22) Filed: Dec. 18, 2002

(51) Int. Cl. G06F 15/00; G06F 9/45

(52) U.S. Cl. 712/23; 717/151

(57) ABSTRACT

A method (and structure) for modeling the timing of production and consumption of data produced and consumed by instructions on a processor using irregular pipeline and/or bypass structures, includes developing a port-based look-up table containing a delay compensation number for pairs of ports in at least one of an irregular pipeline and an irregular bypass structure. Each delay compensation number permits a calculation of an earliest/latest time an instruction can be scheduled.

### BACKGROUND OF THE INVENTION

1. Field of the Invention

The present invention generally relates to code generation, and more particularly to a method and system for modeling exposed pipeline processors for static scheduling.

2. Description of the Related Art

In statically scheduled processors, the scheduling of instructions is performed by an automatic tool (henceforth referred to as a “compiler”), or by an assembly programmer, rather than by processor hardware.

Typically, a set of shared resources, such as register file ports, are needed for executing an instruction in a processor. In very long instruction word (VLIW) processors and other statically scheduled processors using explicitly parallel instruction computing (EPIC) style, several instructions can be statically scheduled together in the same cycle. For the purpose of scheduling instructions on VLIW and EPIC processors, accurate information concerning the shared resources used by each instruction, including precise time in which these resources are used, is needed. In exposed pipeline architectures, the compiler or assembly programmer is responsible for preventing potential resource usage conflicts arising from incorrect scheduling of instructions, because such conflicts are neither detected nor handled by hardware.

One of the steps in static scheduling, either with an automatic tool or by hand (e.g., manual) coding, is to determine the earliest/latest time an instruction can be scheduled given a partial schedule. This is often referred to as the “ready time” of the instruction. The actual time/cycle in which an instruction can be scheduled also depends on the availability of resources used by the instruction.

In an architecture with no bypassing or with full bypassing (e.g., a so-called “regular” pipeline), the ready time of an instruction can be computed easily by considering a limited number of instruction classes (e.g., each class containing instructions using the identical set of pipeline resources).

Furthermore, when an instruction is scheduled, the time/cycle in which its results are available can be recorded, and this information can be used later for scheduling all of its dependent instructions.

In an architecture containing selective bypassing, the “ready time” of an instruction depends on whether data is bypassed to (and from) it or not, and this information depends on the specific ports used by both the instruction and the instructions feeding it (or being fed by it). Therefore, the traditional approach of adding or subtracting a fixed instruction latency to or from the current scheduling cycle to compute the data ready cycle of instructions cannot be used for scheduling instructions in such processor architectures.

There are several publications on code generation techniques and modeling resources of statically scheduled processors, such as Hewlett Packard Technical Report Number HPL-97-39, entitled “Meld Scheduling: A Technique for Relaxing Scheduling Constraints” by S. G. Abraham, V. Kathail, and B. L. Deitrich, February, 1997, and Hewlett Packard Technical Report HPL-98-128, entitled “Elcor's Machine Description System: Version 3.0” by Aditya, S., Kathail, V. and Rau, B. R., October, 1998.

However, none of these techniques has addressed the problem of dealing with “irregular” pipelines with selective bypassing which is the problem first recognized by the present inventors and solved by the present invention. For purposes of the present invention, an “irregular pipeline” is defined as a pipeline structure where the minimum number of cycles that need to be inserted between an instruction and its dependent instruction cannot be precisely determined based only on the pipelines to which these instructions belong.

### SUMMARY OF THE INVENTION

In view of the foregoing and other problems, drawbacks, and disadvantages of the conventional methods and structures, a purpose of the present invention is to provide a method and structure for modeling statically scheduled processors using non-interlocked, exposed pipelines with irregular structures and selective bypassing.

Another purpose is to describe how a simple look-up table can abstract the complexity of irregular structures, for the purpose of code generation using an automated tool such as a compiler.

Accordingly, in a first aspect of the present invention, described herein is a method (and structure) for modeling the timing of production and consumption of data produced and consumed by instructions on a processor using irregular pipeline and/or bypass structures, including providing a port-based look-up table containing a delay compensation number for pairs of ports in at least one of an irregular pipeline and an irregular bypass structure, each delay compensation number permitting a calculation of an earliest/latest time an instruction can be scheduled.

In a second aspect of the present invention, described herein is a method of calculating a ready cycle of an instruction in a computer having at least one of an irregular pipeline structure and an irregular bypass structure, including providing a table of signed delay compensation numbers Dᵢⱼ's for all pairs of write ports WRᵢ's and read ports RDⱼ's of said irregular pipeline structure, each compensation number Dᵢⱼ being a signed number for computing the minimum delay in cycles for accessing a datum through port RDⱼ after said datum was written through port WRᵢ.

In a third aspect of the present invention, described herein is a signal-bearing medium tangibly embodying a program of machine-readable instructions executable by a digital processing apparatus to perform at least one of developing and using a port-based look-up table containing delay compensation numbers for pairs of ports in at least one of an irregular pipeline and an irregular bypass structure, each delay compensation number permitting a calculation of an earliest/latest time an instruction can be scheduled.

Thus, the present invention provides a method and system for modeling pipelines with selective bypassing by a look-up table that supports accurate ready-time computation, which in turn facilitates automatic instruction scheduling optimization in statically scheduled, exposed pipeline VLIW and EPIC architectures.

The method (and structure) of the invention can also make use of “meta” ports-based modeling of virtual resources to specify instruction scheduling constraints. Various aggressive optimizations and transformations used in code generation such as software pipelining and other optimizations such as register allocation can greatly benefit from such an accurate ready-time computation.

The method (and structure) of the invention also provides an efficient way to compute the ready-time for irregular pipeline architectures as it involves only one additional table look-up operation per each dependency relationship between instructions. Therefore, the method can speed up the code generation process for exposed pipeline VLIW and EPIC architectures.

Furthermore, the invention practically eliminates the need for re-writing the code for scheduling and register allocation, thereby making the compiler easily retargettable to different architectures, including (but not limited to) “irregular” pipeline VLIW and EPIC architectures.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 schematically shows an exemplary flow diagram of a code generation scheme, according to the present invention;

FIG. 1A shows an exemplary basic block diagram for an apparatus that implements the flow shown in FIG. 1;

FIG. 2 shows a delay compensation look-up table (LUT) 101, according to the present invention;

FIG. 3 illustrates an exemplary hardware/information handling system 300 for incorporating the present invention therein; and

FIG. 4 illustrates a signal bearing medium 400 (e.g., storage medium) for storing steps of a program of a method according to the present invention.

### DETAILED DESCRIPTION OF PREFERRED EMBODIMENTS OF THE INVENTION

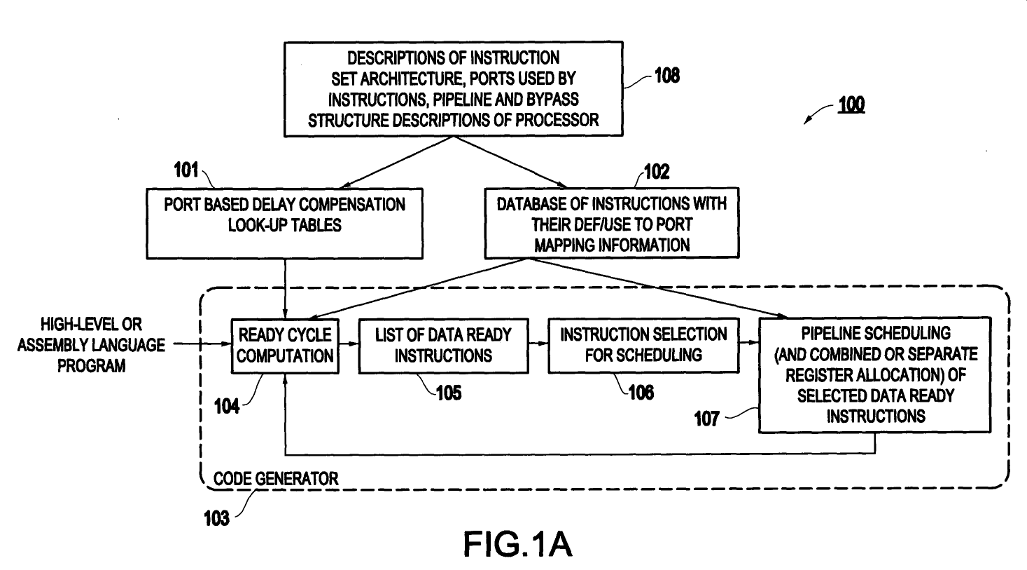

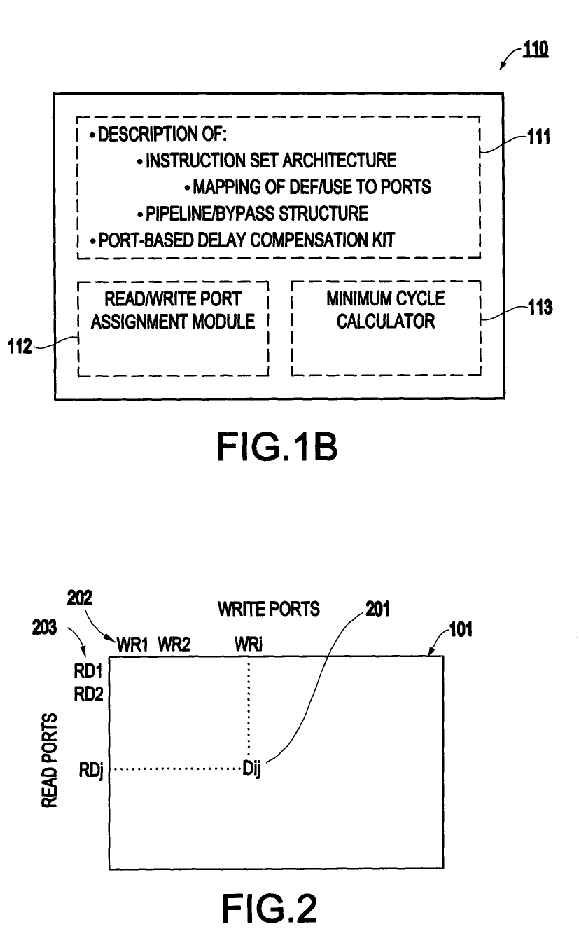

Referring now to the drawings, and more particularly to FIGS. 1-4, there is shown a preferred embodiment of the method and structures according to the present invention.

Generally, the method (and system) of the present invention is directed to a situation in which, given any pair of write and read ports, and the pipeline bypass structure carrying the data from the write port to the read port, it is possible to compute a constant signed “delay compensation” number, such that this number can be added to the difference between the write and read cycles to compute the earliest/latest time an instruction can be scheduled, given the partial schedule of its data-dependent instructions.

Hence, with the invention, it is possible to abstract the delay characteristic of both full-bypass and selective bypass structures (used in irregular pipelines) by a table 101 of delay compensation numbers 201.

The table 101 preferably contains an entry 201 for all pairs of write and read ports 202, 203 that can exchange data residing in a storage, such as a register file in the processor. Such a look-up table (LUT) 101 may be used for efficiently computing the earliest/latest time that an instruction can be scheduled.

Hereinbelow, described in detail are the steps of the method (and the structure) of the present invention.

Before reaching the final code generator, programs written in assembly language or especially in high-level languages, such as a C-language, undergo a number of optimization steps, typically carried out by the front-end of the compiler.

Referring now to FIG. 1, wherein a block diagram/flowchart 100 is shown, including a typical code generator 103 for a statically scheduled processor. The corresponding structural blocks 110 are shown in FIG. 1A.

A first step 104 in the instruction scheduling process is the computation of ready cycles. This computation is well known in the art, as demonstrated by either of the aforementioned Hewlett Packard technical reports and the various reference documents cited in those reports, and thus, for brevity, will not be further described herein.

Once the ready cycles of instructions are known, data ready instructions can be identified by comparing the ready cycle 105 with the current scheduling cycle 106. For example, in a top-down list-scheduling scheme, all instructions that have a ready cycle less than or equal to the current scheduling cycle 106 are considered to be “data ready.”

In addition to the availability of input data, processor resources are required for carrying out computation. In a typical code generator for a statically scheduled processor, checking the availability of resources and reserving them on a cycle-by-cycle basis, is carried out by the pipeline scheduler 107.

An instruction from the list of data ready instructions is selected for pipeline scheduling, which involves scheduling the resources required for carrying out computation. Register allocation is often carried out after or before scheduling, or along with scheduling.

In a traditional processor with fully-bypassed, regular pipeline structures, the ready cycle of an instruction may be computed by taking the maximum value among the sum of latency and issue cycle of each of its dependent instructions.

In a processor with selective bypassing (or “irregular” pipeline) structures, the ready cycle of an instruction depends on the specific data path used for accessing data, which may not necessarily always include a bypass path. According to the present invention, for such processors, a look-up table 101 is constructed, with each element 201 (see FIG. 2) of the table representing a signed delay compensation number such that the ready cycle can be computed accurately and efficiently, as described below.

Referring to such a look-up table as shown in FIG. 2, the delay compensation number 201 for accessing the data written and read through the write port WRi 202 and read port RDj 203 is Dij.

Automatic code generation tools use the terms DEF and USE of instructions for the representation and analysis of instruction dependencies. A DEF denotes the definition (or source) and a USE denotes the use (or destination) of a dependency relationship between a pair of dependent instructions. Such relationships include data flow, output, anti, and input dependencies. For example, one or more DEFs/USEs may be used to represent an input/output operand of an instruction and vice versa.

From the instruction set architecture and machine descriptions 108, a database 102 can be generated containing the information about the read and write ports used by DEFs and USEs, as well as the relative time in which the ports are used with respect to the issue cycle of each instruction of a statically scheduled processor. Then, the minimum number of cycles that need to be inserted between a pair of dependent instructions can be computed as follows.

In general, if instruction Ij depends on instruction Ii, some DEF of Ii is connected to some USE of Ij. If RDj is the read port associated with such a USE and WRi is the write port associated with such a DEF, and TRj and TWi are the cycles in which these ports are used by instruction pairs Ij and Ii relative to their issue cycle, respectively, then the minimum number of cycles required between instructions Ij and Ii is given by the formula:

Mij=Max(TWi−TRj+Dij), (1)

where the maximum is taken over all the pair-wise DEF-USE dependency relationship between the instructions Ii and Ij.

Now if instruction IO depends on instructions I1, I2, . . . In, the ready cycle for IO can be computed by taking the maximum value among the sum of the issue cycle (denoted by ISj) of a dependent instruction and the minimum number of cycles between Ii and the dependent instruction Ij:

Max(ISi+Mij), (2)

where the maximum is taken over j=1 . . . n.

The above scheme of scheduling instructions can be used for scheduling macro instructions consisting of a set of dependent instructions by defining and using the ports of the macro instruction. A person skilled in the art can readily apply the basic idea and the method described above for computing the ready cycle of other scheduling schemes and scheduling instructions in any order (including top-down or bottom-up).

The database 102 of DEF/USE to write/read port mapping information can also be used for computing accurate live ranges for register allocation of code for exposed pipeline architectures. This would provide a granularity at the level of cycles in which ports are used for computing live range information instead of using the traditional instruction issue cycle as the boundaries of live ranges, thus enabling automatic generation of tightly packed code by scheduling instructions in the shadow of another instruction.

Other variations and applications of the basic concepts are possible. For example, additional, non-hardware-related, ports can be used to model irregular instruction-specific bypassing features, for modeling architectures with such diverse bypasses and such ports can be assigned in the table. For example, such a port may be defined to capture different kinds of non-data dependencies or resource constraints between a pair of instructions.

Additional “meta” ports can be used to model irregular accesses of a single datum to more than one write or read port, for modeling architectures with such diverse port assignments and such ports can be assigned in the table. For example, sometimes only a portion of the datum written by an instruction through a write port is used by another instruction using a special data path. In such situations, one can use a “meta” port to represent that portion of the write port for modeling the partial data dependency.

Additionally, port information associated with a set of instructions, typically the set of already-scheduled instructions, can be recorded in a dynamically created look-up table entry to facilitate an efficient determination of the ready-time of a single additional instruction. For example, during scheduling or register allocation, it may be convenient to treat a set of dependent instructions together as a “macro instruction”. In such situations, the delay compensation values, corresponding to ports of the macro instruction representing a dependency relationship between another instruction, can be computed dynamically and entered in an existing, or a dynamically created look-up table.

The port information associated with sets of instructions, typically already scheduled (e.g., the instructions of two distinct basic blocks, or regions such as super-blocks or hyper-blocks) can be recorded in the look-up table 101 to facilitate the efficient determination of the ready-time of a single additional instruction, that is conditionally dependent on the sets. Such situations arise during scheduling an instruction that is dependent on multiple sets of instructions belonging to different basic blocks that may or may not be completely scheduled yet.

The basic techniques described herein can be used in an automated tool (e.g., compiler) or technique for detecting scheduling-distance violations and resulting incorrect execution of code written for processor architectures with exposed, irregular pipelines and selective bypass structures.

Further, the basic techniques described herein can be used in automated tools for scheduling instructions, as would typically be found in compilers, including (but not limited to) instruction scheduling techniques such as list-scheduling, trace scheduling, software pipelining, and hyperblock scheduling.

The structural equivalent of an apparatus 110 embodying the exemplary flow chart shown in of FIG. 1 is shown in FIG. 1A, wherein memory 111 contains the LUT and instruction set data corresponding to 101, 102, and 108 in FIG. 1, and read/write port assignment module 112 and minimum cycle calculator 113 perform the tasks of code generator 103 shown in FIG. 1.

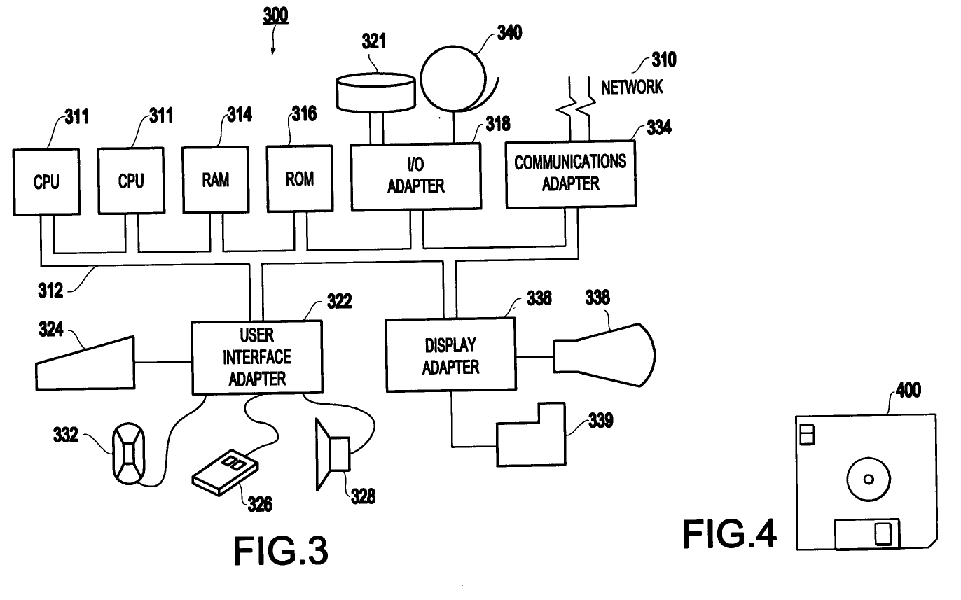

FIG. 3 illustrates a typical hardware configuration of an information handling/computer system for use with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an Intranet, a personal area network (PAN), etc., and a display adapter 336 for connecting the bus 312 to a display device 338 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

With the unique and unobvious features of the present invention, a novel method and system are provided, using a look-up table, for modeling pipelines with selective bypassing to support accurate ready-time computation, which in turn facilitates automatic instruction scheduling optimization in statically scheduled, exposed pipeline VLIW and EPIC architectures.

While the invention has been described in terms of several preferred embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of modeling a timing of production and consumption of data produced and consumed by instructions on a processor using at least one of an irregular pipeline and an irregular bypass structure, said method comprising:
providing a port-based look-up table containing a delay compensation number for pairs of ports in said at least one of the irregular pipeline and the irregular bypass structure, each said delay compensation number permitting a calculation of an earliest/latest time an instruction can be scheduled.

2. The method of claim 1, further comprising:
assigning write and read ports for every datum produced and every datum consumed by an instruction; and
using said look-up table addressable by said read and write ports to determine a minimum number of cycles between a producing or consuming instruction and one or more of its data dependent instructions.

3. The method of claim 2, further comprising:
developing a database of instructions with a mapping information between said read and write ports and a DEF/USE (source/destination) of each said instruction.

4. The method of claim 1, further comprising:
using additional ports to model irregular instruction-specific bypassing features, each said additional port being entered as an address in said look-up table.

5. The method of claim 4, wherein said additional ports comprise ports which are non-hardware-related ports.

6. The method of claim 2, further comprising:
using additional “meta” ports to model irregular accesses of a single datum to at least one of more than one write port and more than one read port.

7. The method of claim 2, further comprising:
recording a port information associated with a set of instructions, said port information being used to facilitate an efficient determination of a ready-time of a single additional instruction that depends on said set.

8. The method of claim 7, wherein said set of instructions comprises a set of already scheduled instructions.

9. The method of claim 2, further comprising:
recording a port information associated with two sets of instructions, said port information being used to facilitate a determination of a minimum number of cycles between said two sets of instructions.

10. The method of claim 9, wherein said two sets of instructions comprise instructions of two distinct basic blocks.

11. The method of claim 1, further comprising:
based on said look-up table, detecting scheduling-distance violations and resulting incorrect execution of code written for processor architectures with said at least one of an irregular pipeline and an irregular bypass structure.

12. The method of claim 1, wherein said method comprises instructions associated with a compiler.

13. The method of claim 12, wherein said compiler executes at least one of:
list-scheduling;
trace scheduling;
software pipelining; and
hyperblock scheduling.

14. An apparatus comprising:
a port-based look-up table containing a delay compensation number for port pairs in at least one of an irregular pipeline and an irregular bypass structure, each said delay compensation number permitting a calculation of an earliest/latest time an instruction can be scheduled.

15. The apparatus of claim 14, further comprising:
a module for assigning write and read ports for every datum produced and every datum consumed by an instruction; and
a calculator for, based on said look-up table addressable by said read and write ports, determining the minimum number of cycles between a producing or consuming instruction and one or more of its dependent instructions.

16. The apparatus of claim 14, wherein said apparatus comprises one of:
a very long instruction word (VLIW) processor; and
a statically scheduled processor using explicitly parallel instruction computing (EPIC) style.

17. A method of calculating a ready cycle of an instruction in a computer having at least one of an irregular pipeline structure and an irregular bypass structure, said method comprising:
providing a table of signed delay compensation numbers Dᵢⱼ's for all pairs of write ports WRᵢ's and read ports RDⱼ's of said irregular pipeline structure, each said compensation number Dᵢⱼ being a signed number for computing the minimum delay in cycles for accessing a datum through port RDⱼ after said datum was written through port WRᵢ.

18. The method of claim 17, further comprising:
developing a database containing information about which ports are used by each DEF (source) and USE (destination) of each instruction; and
using said table and said database to calculate a ready cycle for an instruction.
wherein said ready cycle calculation for an instruction comprises:
given an instruction I0 and a set of n dependent instructions I1, I2, . . . In, calculating a minimum number of cycles between instruction pairs Iᵢ and Iⱼ by determining from said database a read port RDⱼ and a cycle TRⱼ used for said instruction Iⱼ and a write port WRᵢ and cycle TWᵢ used for said instruction Iᵢ;
calculating a minimum number of cycles Mij between said instruction Iᵢ and each dependent instruction Iⱼ by calculating Max(TWᵢ−TRⱼ+Dᵢⱼ)), where the maximum is taken over all the pair-wise DEF-USE (source-destination) dependency relationship between the instructions Iᵢ and Iⱼ; and
computing said ready cycle by finding a maximum value among the sum of issue cycle (denoted by ISⱼ) of a dependent instruction and said minimum distance between Iᵢ and said dependent instruction Ij as described by: Max(ISᵢ+Mᵢⱼ) where the maximum is taken over j=1 . . . n.

19. A signal-bearing medium tangibly embodying a program of machine-readable instructions executable by a digital processing apparatus to perform at least one of developing and using a port-based look-up table containing delay compensation numbers for pairs of ports in at least one of an irregular pipeline and an irregular bypass structure, each said delay compensation number permitting a calculation of an earliest/latest time an instruction can be scheduled.

20. The signal-bearing medium of claim 19, said using comprising at least one of the following:
list-scheduling;
trace scheduling;
software pipelining; and
hyperblock scheduling.
